(19) United States
(12) Patent Application Publication
(10) Pub. No.: US 2026/0289866 A1
(43) Pub. Date: Sep. 24, 2026

(54) METHOD, APPARATUS, DEVICE AND MEDIUM FOR GENERATING MEDIA CONTENT

(71) Applicant: Beijing Zitiao Network Technology Co., Ltd., Beijing (CN)

(72) Inventors: Lei Xu, Beijing (CN); Yuan Zhu, Beijing (CN)

(21) Appl. No.: 19/577,039

(22) Filed: Mar. 24, 2026

(30) Foreign Application Priority Data
Mar. 24, 2025 (CN) 2025103551254

(51) Int. Cl. G06T 11/60

(52) U.S. Cl. CPC G06T 11/60

(57) ABSTRACT

Embodiments of the disclosure relate to a method, an apparatus, a device, and a storage medium for generating media content. The method provided herein includes: presenting a media generation interface including a first area and a second area, the first area presenting a set of media templates and the second area including a prompt information input control; in response to a selection of a first media template from the set of media templates, filling the prompt information input control with first prompt information corresponding to the first media template; constructing a media generation request based on the first prompt information; and providing media content generated based on the media generation request. In this way, embodiments of the present disclosure may improve the efficiency of generating the media content.

### CROSS-REFERENCE TO RELATED APPLICATIONS

This application claims priority to Chinese Patent Application No. 202510355125.4, filed Mar. 24, 2025, entitled “METHOD, APPARATUS, DEVICE AND MEDIUM FOR GENERATING MEDIA CONTENT”, the disclosure of which is incorporated herein by reference in its entirety.

### FIELD

Example embodiments of the present disclosure generally relate to the field of computers, and in particular, to a method, an apparatus, a device, and a computer-readable storage medium for generating media content.

### BACKGROUND

With the development of computer technology, a poster, as an important visual communication tool, is widely used in advertising, publicity, education, personal creation and other fields. A user may quickly generate the poster based on a template-based poster generation tool.

### SUMMARY

In a first aspect of the present disclosure, a method for generating media content is provided. The method includes: presenting a media generation interface, the media generation interface including a first area and a second area, the first area presenting a set of media templates and the second area including a prompt information input control; filling, in response to a selection of a first media template from the set of media templates, the prompt information input control with first prompt information corresponding to the first media template; constructing a media generation request based on the first prompt information; and providing media content generated based on the media generation request.

In a second aspect of the present disclosure, an apparatus for generating media content is provided. The apparatus includes: a presenting module configured to present a media generation interface including a first area and a second area, the first area presenting a set of media templates and the second area including a prompt information input control; a filling module configured to, in response to a selection of a first media template from the set of media templates, fill the prompt information input control with first prompt information corresponding to the first media template; a constructing module configured to construct a media generation request based on the first prompt information; and a providing module configured to provide media content generated based on the media generation request.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The computer-readable storage medium having stored thereon a computer program executable by a processor to implement the method of the first aspect.

It would be understood that the content described in the content section is not intended to limit the key or essential features of embodiments of the present disclosure, nor is it intended to limit the scope of the present disclosure. Other features of the present disclosure will be readily understood from the following description.

### BRIEF DESCRIPTION OF THE DRAWINGS

The above and other features, advantages and aspects of embodiments of the present disclosure will become more apparent from the following detailed description taken in conjunction with the drawings. In the drawings, the same or similar reference numbers refer to the same or similar elements, where:

FIG. 1 illustrates a schematic diagram of an example environment in which embodiments according to the present disclosure may be implemented;

FIGS. 2A to 2I illustrates example interfaces according to some embodiments of the present disclosure;

FIG. 3 illustrates a flowchart of an example process of generating media content according to some embodiments of the present disclosure;

FIG. 4 illustrates a schematic structural block diagram of an example apparatus for generating media content according to some embodiments of the present disclosure; and

FIG. 5 illustrates a block diagram of an electronic device capable of implementing multiple embodiments of the present disclosure.

### DETAILED DESCRIPTION OF EMBODIMENTS

Embodiments of the present disclosure will be described in more detail below with reference to the drawings. Although some embodiments of the present disclosure are shown in the drawings, it would be understood that the present disclosure may be implemented in various forms and should not be construed as limited to the embodiments set forth herein. Instead, these embodiments are provided for a more thorough and complete understanding of the present disclosure. It would be understood that the drawings and embodiments of the present disclosure are only used for illustrative purposes and are not intended to limit the protection scope of the present disclosure.

It should be noted that the titles of any section/subsection provided herein are not restrictive. Various embodiments are described throughout this article, and any type of embodiment may be included under any section/subsection. Furthermore, embodiments described in any section/subsection may be combined in any manner with any other embodiments described in the same section/subsection and/or different section/subsection.

In the description of embodiments of the present disclosure, the term "including" and similar terms should be understood as openness, that is, "including but not limited to". The term "based on" should be understood as " based at least in part on". The term "one embodiment" or "the embodiment" should be understood as "at least one embodiment". The term "some embodiments" should be understood as "at least some embodiments". Other explicit and implicit definitions may also be included below. The terms "first", "second", etc. may refer to different or same objects. Other explicit and implicit definitions may also be included below.

Embodiments of the present disclosure may relate to data of a user, acquisition and/or use of data, etc. These aspects all follow the corresponding laws, regulations and related regulations. In embodiments of the present disclosure, all data collection, acquisition, processing, processing, forwarding, use, etc. are performed on the premise that the user knows and confirms. Accordingly, when implementing the various embodiments of the present disclosure, the types, range of use, use scenarios, etc. of the data or information that may be involved should be notified to the user and the authorization of the user should be obtained in an appropriate manner according to the relevant laws and regulations. The specific manner of notification and/or authorization may vary according to the actual situation and application scenarios, and the scope of the present disclosure is not limited in this respect.

If the solutions in this specification and embodiments involve personal information processing, the processing will be performed on the premise of having a legal basis (for example, the consent of the personal information subject is obtained, or it is necessary to perform a contract, etc.), and the processing will only be performed within the scope of the provisions or agreements. If the user refuses to process personal information other than the necessary information required by the basic functions, it will not affect the user's use of the basic functions.

As mentioned above, a user may quickly generate a poster based on a template-based poster generation tool. However, due to the limitation of a predefined template, the generated poster cannot reflect the personalized needs of the user. Moreover, the user needs to manually adjust the text, layout, etc. of the poster, which is not optimized for the non-professional user.

Embodiments of the present disclosure provide a solution for generating media content. The solution includes: presenting a media generation interface including a first area and a second area, the first area presenting a set of media templates and the second area including a prompt information input control; filling, in response to a selection of a first media template from the set of media templates, the prompt information input control with first prompt information corresponding to the first media template; constructing a media generation request based on the first prompt information; and providing media content generated based on the media generation request.

In this way, by filling the prompt information corresponding to the template into the prompt information input control, the user may modify the prompt information or directly use the prompt information, and the media content may be generated based on the prompt information. Therefore, embodiments of the present disclosure may improve the efficiency of generating the media content.

Various example implementations of the solution are described in detail below in further conjunction with the drawings.

### Example Environment

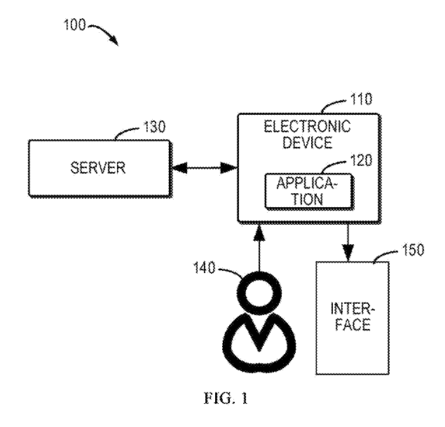

FIG. 1 illustrates a schematic diagram of an example environment 100 in which embodiments of the present disclosure may be implemented. As shown in FIG. 1, the example environment 100 may include an electronic device 110.

In the example environment 100, the electronic device 110 may run an application 120 supporting media content generation. The application 120 may be any suitable type of application for generating media content, examples of which may include but are not limited to a media application or other suitable applications that provide media generation functions. A user 140 may interact with the application 120 via the electronic device 110 and/or its attached devices.

In the environment 100 of FIG. 1, if the application 120 is active, the electronic device 110 may present an interface 150 for supporting media content generation through the application 120.

In some embodiments, the electronic device 110 communicates with a server 130 to implement the provision of services for the application 120. The electronic device 110 may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the above, including the accessories and peripherals of these devices or any combination thereof. In some embodiments, the electronic device 110 may also support any type of user-specific interface (such as a "wearable" circuit, etc.).

The server 130 may be an independent physical server, a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, and the like. The server 130 may provide background services for the application 120 supporting media content generation in the electronic device 110.

A communication connection may be established between the server 130 and the electronic device 110. The communication connection may be established by wired or wireless means. The communication connection may include, but is not limited to, a Bluetooth connection, a mobile network connection, a universal serial bus (USB) connection, a wireless fidelity (WiFi) connection, etc. Embodiments of the present disclosure are not limited in this aspect. In embodiments of the present disclosure, the server 130 and the electronic device 110 may implement signaling interaction through a communication connection the two.

It would be understood that the structures and functions of various elements in the environment 100 are described for example purposes only, and do not imply any limitation to the scope of the present disclosure.

Some example embodiments of the present disclosure will be described below with continued reference to the drawings.

### Example Interaction

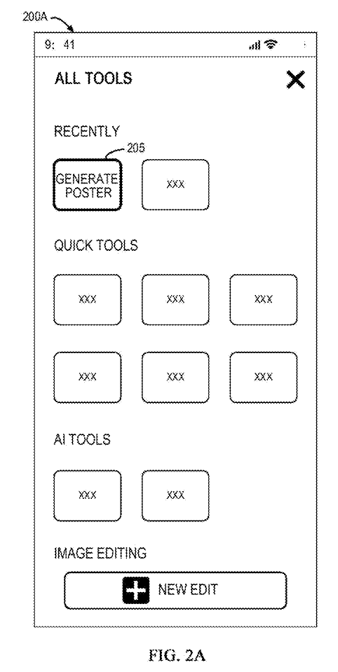

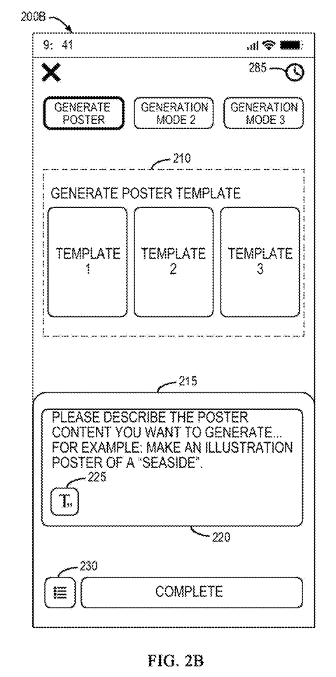

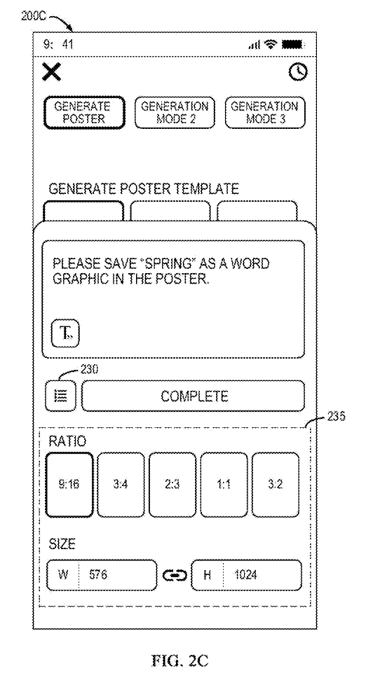

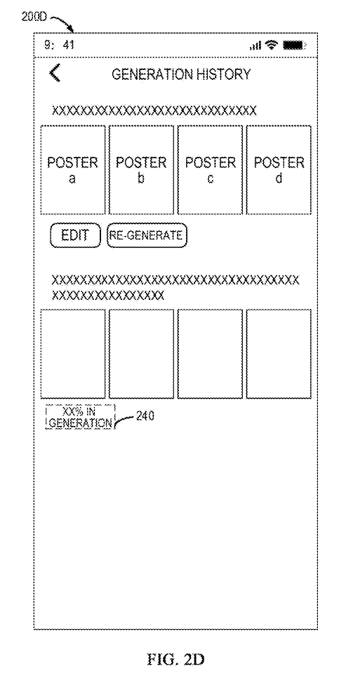

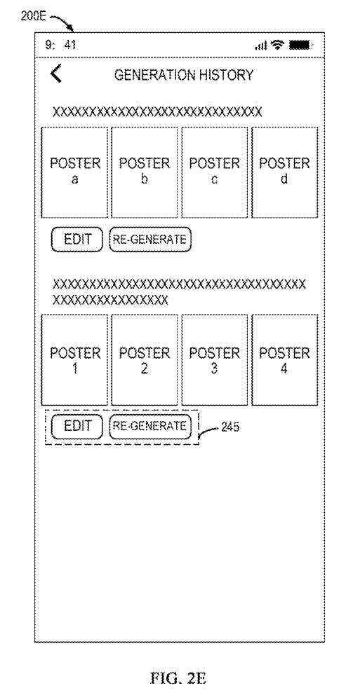

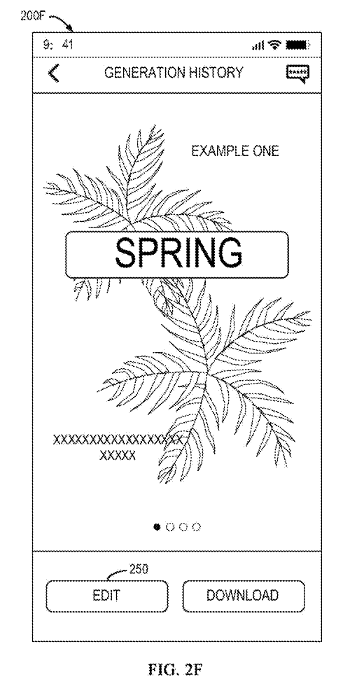

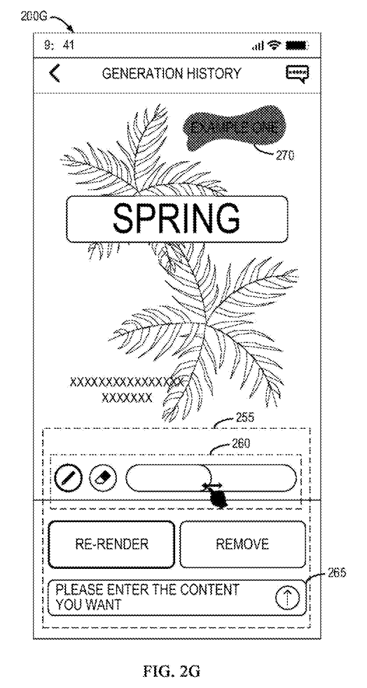

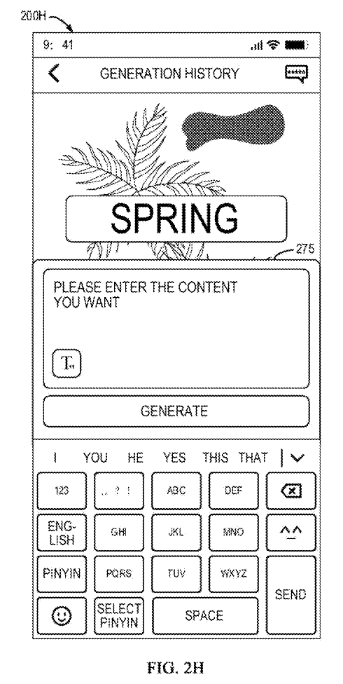

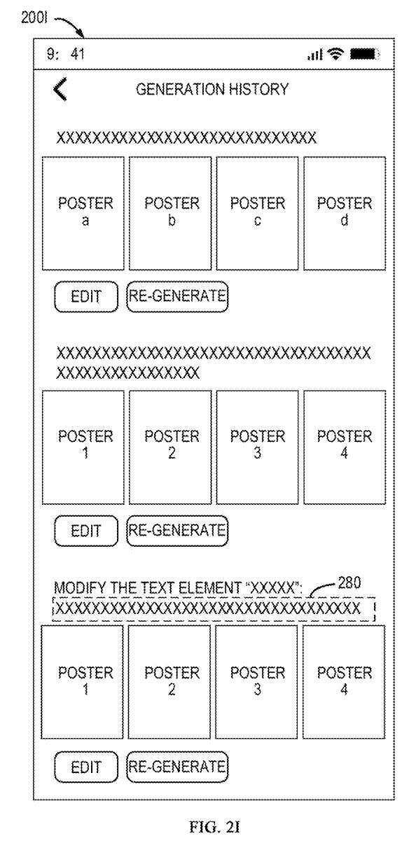

FIGS. 2A to 2I illustrate example interfaces 200A to 200I according to some embodiments of the present disclosure. The interfaces 200A to 200I may be provided by, for example, an electronic device 110 shown in FIG. 1.

In some embodiments, as shown in FIG. 2A, the electronic device 110 may present a tool interface 200A. Specifically, the tool interface 200A includes a tool 205 for generating media content.

In some examples, the tool interface 200A may include multiple types of tools. For example, quick tools and image editing tools. The electronic device 110 presents different types of tools in a partitioned manner, which is convenient for a user to quickly find a target type of tool.

In some examples, the tool interface 200A may further include a recently used tool. For example, the tool 205 for generating media content. The electronic device 110 presents the tools recently used by the user at the top of the tool interface 200A, which is beneficial to meet the user's usage habits for the tools.

In other examples, the tool 205 for generating media content may include text content (for example, a generated poster), so as to remind the user of the function of the tool 205 for generating media content.

In some embodiments, as shown in FIG. 2B, the electronic device 110 may present a media generation interface 200B in response to a selection of the tool 205 for generating media content. Specifically, the media generation interface 200B includes a first area 210 and a second area 215.

In some embodiments, the media generation interface 200B may present a set of generation controls. The media generation interface 200B may support multiple generation modes. As an example, the electronic device 110 may determine a target generation mode of the media generation interface in response to a selection of a target control from the set of generation controls. For example, the generation mode supported by the media generation interface may be poster generation.

In some examples, the electronic device 110 may present a generated poster control in a selected style, for example, by bolding an edge of the generated poster, to indicate that the function of the media generation interface 200B is to generate a poster.

As shown in FIG. 2B, the first area 210 may present a set of media templates. The number of the set of media templates may be 3 or other numbers. The electronic device 110 may present other media templates based on the user's swipe operation (for example, swiping left or right) in the first area 210.

In some examples, the first area 210 may include text content (for example, a generated poster template), so as to remind the user of the function of the first area 210.

In some examples, the set of media templates in the first area 210 may be preset templates or may be generated based on other users. For example, template 1 and template 2 may be preset templates, and template 3 may be generated based on other users.

In some examples, the set of media templates may include a preview image (not shown in the figure) to help the user select a corresponding media template based on the preview image.

As shown in FIG. 2B, the second area 215 may include a prompt information input control 220. As an example, the prompt information input control 220 may include prompt text to remind the user that a text prompt may be input in the prompt information input control 220 to generate a poster. The prompt text may be: please describe the poster content you want to generate... For example: make an illustration poster of a "seaside".

As shown in FIG. 2B, the prompt information input control 220 may include a first control 225. Specifically, the first control 225 may be used to input a preset indicator. As an example, the preset indicator may be a double quote. For example, the user may input the text content Happy New Year and select the first control 225 to generate the text content in the prompt information input control 220: "Happy New Year".

In some embodiments, the electronic device 110 may fill the prompt information input control 220 with first prompt information corresponding to a first media template (which may be, for example, template 1) in response to a selection of the first media template from the set of media templates. As an example, the user may select template 1, so that the prompt information input control 220 presents the first prompt information corresponding to template 1.

In some examples, the first prompt information corresponding to template 1 may be: please save "spring" as a word graphic in the poster.

In some embodiments, the electronic device 110 may determine target prompt information based on the prompt information input control 220. Further, the target prompt information may be determined based on the first prompt information, or may be determined based on second prompt information obtained by editing the first prompt information.

In some embodiments, the user may directly edit the first prompt information in the prompt information input control 220. As an example, the user may directly modify the first prompt information to: please save "summer" as a word graphic in the poster.

In some examples, the user may also edit the first prompt information by selecting the first control 225. For example, the user may add text content with double quotes to the first prompt information based on the first control 225. Thus, the first prompt information is modified to: please save "spring" as a word graphic in the poster, "outing".

In some embodiments, the electronic device 110 may construct a media generation request based on the target prompt information. Further, the electronic device 110 may generate media content based on the media generation request.

In some examples, the electronic device 110 may identify the text content indicated by the preset indicator in the first information, and save the text content as a word graphic in the media content. For example, the first prompt information is: please save "spring" as a word graphic in the poster, "outing". The electronic device 110 may save spring and outing as word graphics in the media content.

In some embodiments, the media generation interface 200B may include a second control 230. The second control 230 is used to present at least one parameter configuration control. Further, the electronic device 110 may determine at least one media generation parameter based on the at least one parameter configuration control, and construct the media generation request based on the at least one media generation parameter and the target prompt information.

In some embodiments, as shown in FIG. 2C, the electronic device 110 may present at least one media generation parameter 235 in a media generation interface 200C in response to a trigger of the second control 230 in the media generation interface 200B. As an example, the at least one media generation parameter 235 may include a scale parameter and a size parameter.

In some examples, a set of scale parameters may be presented in the media generation interface 200C. The user may select a target scale parameter (for example, 9:16) to determine a first media generation parameter.

In some examples, after receiving the user's selection of template 1, the electronic device 110 may present prompt information in response to the user's selection of the target scale parameter, so as to remind the user of the suitable scale of template 1. For example, if the suitable scale of template 1 is 3:4, when the user selects the scale of 9:16, the electronic device 110 will prompt the user: the suitable scale of template 1 is 3:4.

In some examples, a size parameter control may be presented in the media interface 200C. The user may input a target size parameter (for example, W: 576; H: 1024) in the size parameter control to determine a second media generation parameter. An aspect ratio in the target size parameter may not be a fixed ratio, so that the user may flexibly configure the size of the media content.

In some embodiments, with continued reference to FIG. 2B, the electronic device 110 may determine text content to be visualized based on the media generation request. Further, the electronic device 110 may generate a control feature corresponding to the text content, and the media content is generated by the media generation model based on the control feature and the media generation request. As an example, the text content may be spring, and the control feature may represent position information of a word graphic corresponding to spring in the media content. The position information may be determined based on a position mask. The position mask may be a pixel or a coordinate of the word graphic in the media content.

In some examples, the model may automatically determine the position information based on the text content. For example, the model may understand and encode spring, and then present the word graphic corresponding to spring in a position that is upper middle in the media content.

In some examples, the electronic device 110 may receive a position message input by the user in the prompt information input control 220, and determine the position information based on the position message. For example, the position message input by the user is: display "spring" in the upper left corner of the poster, and the electronic device 110 may present the word graphic corresponding to spring in the upper left corner of the media content.

In some embodiments, as shown in FIG. 2D, the electronic device 110 may present a historical generation interface 200D in response to a selection of a completion control in the media generation interface 200B. The historical generation interface 200D may include a set of historically generated posters, such as poster a, poster b, poster c and poster d.

In some examples, the electronic device 110 may present progress information 240 in the historical generation interface 200D in response to the media content being generated. The progress information 240 may include, for example, text content XX% in generation to indicate a current generation progress of the media content.

In some embodiments, as shown in FIG. 2E, the electronic device 110 may present the media content in a historical generation interface 200E and update the progress information 240 to a control 245 in response to a completion of the media content generation. As an example, the media content may include poster 1, poster 2, poster 3 and poster 4. The control 245 may include an edit control and a re-generation control.

In some examples, the electronic device 110 may re-generate the media content in the historical generation interface 200E in response to a selection of the re-generation control.

In some embodiments, as shown in FIG. 2F, the electronic device 110 may present an edit interface 200F of the media content in response to a selection of the edit control in the historical generation interface 200E. As an example, the edit interface 200F may present the media content corresponding to poster 1.

In some embodiments, the edit interface 200F may present multiple layers of the media content. As an example, the media content may include 4 layers. The first layer presents a word graphic corresponding to spring; the second layer presents a word graphic corresponding to example one; the third layer presents a background graphic; and the fourth layer presents a word graphic corresponding to other text content.

In some examples, the user may view other media content, such as poster 2, poster 3 or poster 4, by swiping right in the edit interface 200F.

In some examples, the user may download the media content in the edit interface 200F.

In some embodiments, as shown in FIG. 2G, the electronic device 110 may present a set of controls 255 in an edit interface 200G in response to a selection of an edit control 250 in the edit interface 200F. Specifically, the set of controls 255 may include a selection control 260, a re-render control, a remove control and a modify text element control 265.

In some embodiments, the electronic device 110 may select a selection tool of the selection control 260 and determine the thickness of the selection tool by swiping an indicator left and right.

In some embodiments, the electronic device 110 may determine an area 270 based on the selection tool. As an example, the area 270 corresponds to the word graphic corresponding to example one.

In some embodiments, the electronic device 110 may cause the electronic device 110 or the server 130 to re-generate the graphic corresponding to the second layer in response to a selection of the re-render control. Further, the electronic device 110 generates the edited media content based on the updated second layer and the other layers.

In some embodiments, the electronic device 110 may remove the graphic (which may also be referred to as a visual element) corresponding to the second layer in response to a selection of the remove control. Further, the electronic device 110 generates the edited media content based on the updated second layer and the other layers.

In some embodiments, as shown in FIG. 2H, the electronic device 110 may present a panel 275 in an edit interface 200H in response to a selection of the modify text element control 265. As an example, the user may input the text content based on the panel 275: please modify "example one" to "example two". The electronic device 110 may understand the text content input by the user through the model, identify example one and example two, and modify the word graphic corresponding to example one in the second layer to the word graphic corresponding to example two. Further, the electronic device 110 generates the edited media content based on the updated second layer and the other layers.

In some embodiments, as shown in FIG. 2I, the electronic device 110 may present the media content corresponding to the modification of the text element in a historical generation interface 200I in response to a modification of the text element in the second layer. As an example, the electronic device 110 may present edited poster 1, poster 2, poster 3 and poster 4. The electronic device 110 presents the text content near the edited poster 1, poster 2, poster 3 and poster 4: modify the text element "example one" to indicate the modification basis of the edited poster 1, poster 2, poster 3 and poster 4.

In some embodiments, the historical generation interface 200I may present at least one content item corresponding to at least one edit operation. As an example, the at least one content item may include a content item 280. The content item 280 corresponds to the modification of the text element in the second layer of poster 1. The content item 280 may include description information and an edit result of editing poster 1. As an example, the content item 280 may include the text content: after editing poster 1, the word graphic corresponding to the text element in the selected area is re-generated, and the text content corresponding to the word graphic is example two.

In some embodiments, with continued reference to FIG. 2B, the media generation interface 200B may include a history entry 285. The electronic device 110 may present the historical generation interface in response to a selection of the history entry 285. As an example, the electronic device 110 may present the historical generation interface 200I. In some examples, the user may swipe down in the historical generation interface 200I, so that the electronic device 110 presents other generated or edited media content.

In this way, by filling the prompt information corresponding to the template into the prompt information input control, the user may modify the prompt information or directly use the prompt information, and the media content may be generated based on the prompt information. Therefore, embodiments of the present disclosure may improve the efficiency of generating the media content.

### Example Process

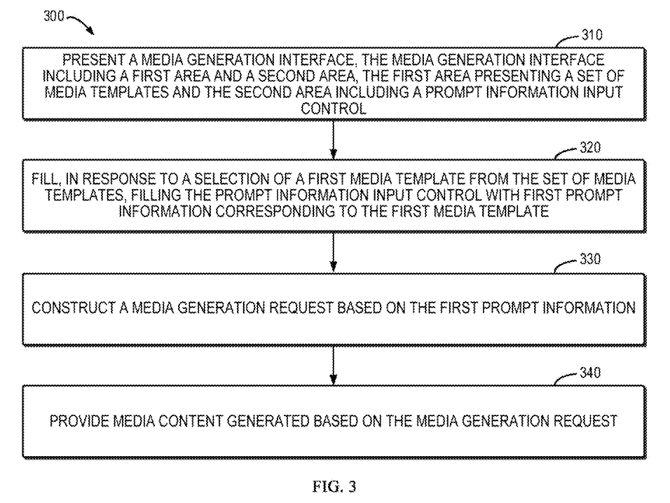

FIG. 3 illustrates a flowchart of an example process 300 of generating media content according to some embodiments of the present disclosure. The process 300 may be implemented at an electronic device 110. The process 300 is described below with reference to FIG. 1.

As shown in FIG. 3, at block 310, the electronic device 110 presents a media generation interface including a first area and a second area, the first area presenting a set of media templates and the second area including a prompt information input control.

At block 320, the electronic device 110 fills the prompt information input control with first prompt information corresponding to a first media template from the set of media templates in response to a selection of the first media template.

At block 330, the electronic device 110 constructs a media generation request based on the first prompt information.

At block 340, the electronic device 110 provides media content generated based on the media generation request.

In some embodiments, constructing the media generation request based on the first prompt information includes: determining target prompt information via the prompt information input control, the target prompt information being the first prompt information or second prompt information obtained by editing the first prompt information; and constructing the media generation request based on the target prompt information.

In this way, by allowing a user to adjust the prompt information, a system may generate more expected media content, thereby improving the quality and relevance of the generated media.

In some embodiments, the target prompt information includes text content indicated by a preset indicator, and the generated media content includes a graphic representation corresponding to the text content.

In this way, embodiments of the present disclosure may generate the corresponding graphic representation according to the text content in the target prompt information. This precise mapping relationship ensures a high degree of consistency between the generated media content and the text content provided by the user, thereby improving the accuracy and relevance of the generated content.

In some embodiments, the prompt information input control includes a first control for inputting the preset indicator.

In this way, a design of the first control in embodiments of the present disclosure enables the user to quickly select and input the preset indicator, thereby reducing the input time and improving the overall operation efficiency.

In some embodiments, constructing the media generation request based on the target prompt information includes: presenting at least one parameter configuration control in response to a trigger of a second control in the media generation interface; determining at least one media generation parameter based on the at least one parameter configuration control; and constructing the media generation request based on the target prompt information and the at least one media generation parameter.

In this way, embodiments of the present disclosure may provide at least one parameter configuration control, allowing the user to customize the media generation parameter as needed. This flexibility enables the user to more precisely control the process and result of media generation, thereby satisfying personalized needs.

In some embodiments, the media content is generated based on the following process: determining text content to be visualized based on the media generation request; generating a control feature corresponding to the text content; and generating the media content by a media generation model based on the media generation request and the control feature.

In this way, embodiments of the present disclosure may determine the text content to be visualized based on the media generation request, and generate the corresponding control feature. This precise mapping relationship ensures a high degree of consistency between the generated media content and the text content, thereby improving the accuracy and relevance of the generated content.

In some embodiments, the control feature further indicates position information of the graphic representation corresponding to the text content, and the position information is determined based on a position mask.

In this way, the introduction of the position information in embodiments of the present disclosure enables the user to more flexibly customize a layout of the media content. This customizability enhances the applicability of the system and satisfies the personalized needs of different users.

In some embodiments, the position mask includes a preset first position mask or a second position mask indicated by the media generation request.

In this way, embodiments of the present disclosure may precisely control the position of the graphic representation by using the preset first position mask or the customized second position mask, thereby ensuring that the generated content meets the user's expectations. This precision improves the quality and relevance of the generated content.

In some embodiments, the process 300 further includes: presenting an edit interface of the media content; and editing the media content via at least one edit operation received in the edit interface.

In this way, by presenting the edit interface of the media content, the user may directly edit the generated media content in embodiments of the present disclosure. This direct control capability enables the user to more flexibly adjust and optimize the media content to satisfy personalized needs.

In some embodiments, the at least one edit operation includes at least one of: a first edit operation for re-rendering a first area of the media content; a second edit operation for removing a visual element in a second area of the media content; and a third edit operation for modifying a text element in the media content.

In this way, by supporting multiple edit operations, the user may precisely adjust the media content in embodiments of the present disclosure, thereby ensuring that the final output media content meets the high-quality standard. This quality improvement capability meets the high requirements of the user for visual effects.

In some embodiments, editing the media content via the at least one edit operation received in the edit interface includes: presenting a plurality of layers of the media content in the edit interface; and receiving a layer edit operation for at least one of the plurality of layers to edit the media content.

In this way, by decomposing the media content into multiple layers, the user may independently edit each layer in embodiments of the present disclosure. This layered editing method provides higher flexibility, allowing the user to more precisely control each part of the media content.

In some embodiments, the process 300 further includes: presenting at least one content item corresponding to the at least one edit operation in a viewing interface, the at least one content item including edit description information and an edit result corresponding to a respective edit operation.

In this way, by presenting the content item (including the edit description information and the edit result) corresponding to the edit operation in the viewing interface, the user may clearly understand the specific content and effect of each edit operation in embodiments of the present disclosure. This transparency makes the editing process more traceable and easy to understand and adjust.

### Example Apparatus and Device

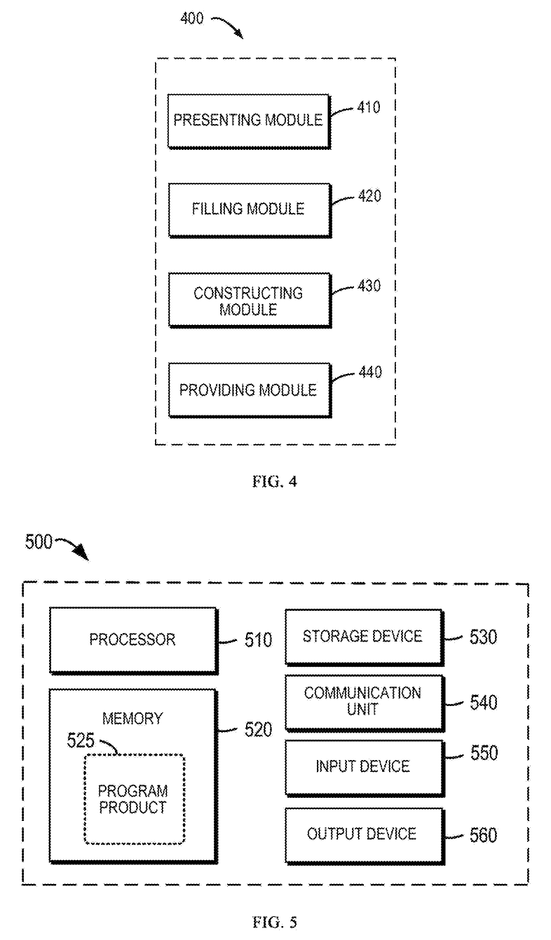

Embodiments of the present disclosure further provide a corresponding apparatus for implementing the above method or process. FIG. 4 illustrates a schematic structural block diagram of an example apparatus 400 for generating media content according to some embodiments of the present disclosure. The apparatus 400 may be implemented as or included in an electronic device 110. Each module/component in the apparatus 400 may be implemented by hardware, software, firmware, or any combination thereof.

As shown in FIG. 4, the apparatus 400 includes: a presenting module 410 configured to present a media generation interface including a first area and a second area, the first area presenting a set of media templates and the second area including a prompt information input control; a filling module 420 configured to, in response to a selection of a first media template from the set of media templates, fill the prompt information input control with first prompt information corresponding to the first media template; a constructing module 430 configured to construct a media generation request based on the first prompt information; and a providing module 440 configured to provide media content generated based on the media generation request.

In some embodiments, constructing the media generation request based on the first prompt information includes: determining target prompt information via the prompt information input control, the target prompt information being the first prompt information or second prompt information obtained by editing the first prompt information; and constructing the media generation request based on the target prompt information.

In some embodiments, the target prompt information includes text content indicated by a preset indicator, and the generated media content includes a graphic representation corresponding to the text content.

In some embodiments, the prompt information input control includes a first control for inputting the preset indicator.

In some embodiments, constructing the media generation request based on the target prompt information includes: presenting at least one parameter configuration control in response to a trigger of a second control in the media generation interface; determining at least one media generation parameter based on the at least one parameter configuration control; and constructing the media generation request based on the target prompt information and the at least one media generation parameter.

In some embodiments, the media content is generated based on the following process: determining text content to be visualized based on the media generation request; generating a control feature corresponding to the text content; and generating the media content by a media generation model based on the media generation request and the control feature.

In some embodiments, the control feature further indicates position information of the graphic representation corresponding to the text content, the position information being determined based on a position mask.

In some embodiments, the position mask includes a preset first position mask or a second position mask indicated by the media generation request.

In some embodiments, the apparatus 400 further includes an editing module configured to present an edit interface of the media content; and edit the media content via at least one edit operation received in the edit interface.

In some embodiments, the at least one edit operation includes at least one of: a first edit operation for re-rendering a first area of the media content; a second edit operation for removing a visual element in a second area of the media content; and a third edit operation for modifying a text element in the media content.

In some embodiments, editing the media content via the at least one edit operation received in the edit interface includes: presenting a plurality of layers of the media content in the edit interface; and receiving a layer edit operation for at least one of the plurality of layers to edit the media content.

In some embodiments, the apparatus 400 further includes a presenting content item module configured to present at least one content item corresponding to the at least one edit operation in a viewing interface, the at least one content item including edit description information and an edit result corresponding to a respective edit operation.

As shown in FIG. 5, an electronic device 500 is in the form of a general electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor, and may execute various processes according to programs stored in the memory 520. In a multi-processor system, multiple processing units execute computer executable instructions in parallel, so as to improve the parallel processing capability of the electronic device 500.

The electronic device 500 usually includes a plurality of computer storage medium. Such medium may be any available medium that is accessible to the electronic device 500, including, but not limited to, volatile and non-volatile medium, and removable and non-removable medium. The memory 520 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 530 may be a removable or non-removable medium, and may include a machine-readable medium, such as a flash drive, a disk, or any other medium, which may be capable of storing information and/or data and may be accessed within the electronic device 500.

The electronic device 500 may further include additional removable/non-removable, volatile/non-volatile memory medium. Although not shown in FIG. 5, a disk driver for reading from or writing into a removable and non-volatile disk (such as a "floppy disk"), and an optical disk driver for reading from or writing into a removable and non-volatile optical disk may be provided. In these cases, each driver may be connected to a bus (not shown) by one or more data medium interfaces. The memory 520 may include a computer program product 525, which has one or more program modules configured to perform various methods or acts of the various embodiments of the present disclosure.

The communication unit 540 enables communication with other electronic devices via a communication medium. Additionally, the functions of the components of the electronic device 500 may be implemented by a single computing cluster or multiple computing machines, which may communicate via communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) as needed through the communication unit 540, the external devices such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to example implementations of the present disclosure, there is provided a computer-readable storage medium having computer executable instructions stored thereon, the computer executable instructions being executed by a processor to implement the method described above. According to example implementations of the present disclosure, there is further provided a computer program product tangibly stored on a non-transitory computer-readable medium and including computer executable instructions, the computer executable instructions being executed by a processor to implement the method described above.

Various aspects of the present disclosure are described herein with reference to flowcharts and/or block diagrams of methods, apparatuses, devices and computer program products implemented according to the present disclosure. It would be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce means for implementing the functions/acts specified in one or more blocks of the flowcharts and/or block diagrams. These computer-readable program instructions may also be stored in a computer-readable storage medium, these instructions cause a computer, a programmable data processing apparatus, and/or other devices to function in a particular manner, and such that, the computer-readable medium storing the instructions includes article of manufacture, which includes instructions for implementing various aspects of the functions/acts specified in one or more blocks of the flowcharts and/or block diagrams.

The computer-readable program instructions may be loaded onto a computer, another programmable data processing apparatus, or other devices, so that a series of operation steps are performed on the computer, another programmable data processing apparatus, or other devices to produce a computer-implemented process, thereby causing the instructions executed on the computer, another programmable data processing apparatus, or other devices to implement the functions/acts specified in one or more blocks of the flowcharts and/or block diagrams.

The flowcharts and block diagrams in the drawings show the possibly implemented architectures, functions, and operations of the systems, methods, and computer program products according to multiple implementations of the present disclosure. In this regard, each block in the flowchart or block diagram may represent a module, program segment, or part of an instruction, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and a combination of blocks in the block diagrams and/or flowcharts may be implemented by a special-purpose hardware-based system that executes specified functions or acts, or may be implemented by a combination of special-purpose hardware and computer instructions.

The implementations of the present disclosure have been described above, which are example, non-exhaustive, and is not limited to the disclosed implementations. Without departing from the scope and spirit of the illustrated implementations, many modifications and changes will be apparent to those of ordinary skill in the art. The terms used herein are selected to best explain the principles of the implementations, the practical applications, or improvements to the technologies in the market, or to enable other those of ordinary skill in the art to understand the implementations disclosed herein.

1. A method for generating media content, comprising:
presenting a media generation interface, the media generation interface comprising a first area and a second area, the first area presenting a set of media templates, and the second area comprising a prompt information input control;
filling, in response to a selection of a first media template from the set of media templates, the prompt information input control with first prompt information corresponding to the first media template;
constructing a media generation request based on the first prompt information; and
providing media content generated based on the media generation request.

2. The method of claim 1, wherein constructing the media generation request based on the first prompt information comprises:
determining target prompt information via the prompt information input control, the target prompt information being the first prompt information or second prompt information obtained by editing the first prompt information; and
constructing the media generation request based on the target prompt information.

3. The method of claim 2, wherein the target prompt information comprises text content indicated by a preset indicator, and the generated media content comprises a graphic representation corresponding to the text content.

4. The method of claim 3, wherein the prompt information input control comprises a first control for inputting the preset indicator.

5. The method of claim 2, wherein constructing the media generation request based on the target prompt information comprises:
presenting at least one parameter configuration control in response to a trigger of a second control in the media generation interface;
determining at least one media generation parameter based on the at least one parameter configuration control; and
constructing the media generation request based on the target prompt information and the at least one media generation parameter.

6. The method of claim 2, wherein the media content is generated based on the following process:
determining text content to be visualized based on the media generation request;
generating a control feature corresponding to the text content; and
generating the media content by a media generation model based on the media generation request and the control feature.

7. The method of claim 6, wherein the control feature further indicates position information of a graphic representation corresponding to the text content, the position information being determined based on a position mask.

8. The method of claim 7, wherein the position mask comprises a preset first position mask, or a second position mask indicated by the media generation request.

9. The method of claim 1, further comprising:
presenting an edit interface of the media content; and
editing the media content via at least one edit operation received in the edit interface.

10. The method of claim 9, wherein the at least one edit operation comprises at least one of:
a first edit operation for re-rendering a first area of the media content;
a second edit operation for removing a visual element in a second area of the media content; and
a third edit operation for modifying a text element in the media content.

11. The method of claim 9, wherein editing the media content via the at least one edit operation received in the edit interface comprises:
presenting a plurality of layers of the media content in the edit interface; and
receiving a layer edit operation for at least one of the plurality of layers to edit the media content.

12. The method of claim 9, further comprising:
presenting at least one content item corresponding to the at least one edit operation in a viewing interface, the at least one content item comprising edit description information and an edit result corresponding to a respective edit operation.

13. An electronic device, comprising:
at least one processor; and
wherein at least one memory coupled to the at least one processor and storing instructions for execution by the at least one processor, the instructions, when executed by the at least one processor, cause the electronic device to perform acts comprising:
presenting a media generation interface, the media generation interface comprising a first area and a second area, the first area presenting a set of media templates, and the second area comprising a prompt information input control;
filling, in response to a selection of a first media template from the set of media templates, the prompt information input control with first prompt information corresponding to the first media template;
constructing a media generation request based on the first prompt information; and
providing media content generated based on the media generation request.

14. The device of claim 13, wherein constructing the media generation request based on the first prompt information comprises:
determining target prompt information via the prompt information input control, the target prompt information being the first prompt information or second prompt information obtained by editing the first prompt information; and
constructing the media generation request based on the target prompt information.

15. The device of claim 14, wherein the target prompt information comprises text content indicated by a preset indicator, and the generated media content comprises a graphic representation corresponding to the text content.

16. The device of claim 15, wherein the prompt information input control comprises a first control for inputting the preset indicator.

17. The device of claim 14, wherein constructing the media generation request based on the target prompt information comprises:
presenting at least one parameter configuration control in response to a trigger of a second control in the media generation interface;
determining at least one media generation parameter based on the at least one parameter configuration control; and
constructing the media generation request based on the target prompt information and the at least one media generation parameter.

18. The device of claim 14, wherein the media content is generated based on the following process:
determining text content to be visualized based on the media generation request;
generating a control feature corresponding to the text content; and
generating the media content by a media generation model based on the media generation request and the control feature.

19. The device of claim 18, wherein the control feature further indicates position information of a graphic representation corresponding to the text content, the position information being determined based on a position mask.

20. A non-transitory computer-readable storage medium having stored thereon a computer program executable by a processor to implement the method, comprising:
presenting a media generation interface, the media generation interface comprising a first area and a second area, the first area presenting a set of media templates, and the second area comprising a prompt information input control;
filling, in response to a selection of a first media template from the set of media templates, the prompt information input control with first prompt information corresponding to the first media template;
constructing a media generation request based on the first prompt information; and
providing media content generated based on the media generation request.
